(19) United States
(12) Patent Application Publication
(10) Pub. No.: US 2011/0214233 A1
(43) Pub. Date: Sep. 8, 2011

(54) Bed-Making Apparatus and Continuous Web of Sheet Sets for Use Therewith

(76) Inventor: Gordon Stang, Major (CA)

(21) Appl. No.: 13/043,137

(22) Filed: Mar. 8, 2011

(30) Foreign Application Priority Data
Mar. 8, 2010 (CA) 2695912

(51) Int. Cl. A47C 21/02; A47C 21/00; B32B 3/00

(52) U.S. Cl. 5/488; 428/57

(57) ABSTRACT

A bed-making apparatus for changing a sheet set on a bed has a delivery guide and a rotatably mounted receiving roller for mounting at ends of a bed. A continuous web of sheet sets is formed by releasably fastening head edges of bottom sheets to foot edges of adjacent bottom sheets, and a plurality of top sheets are attached to the continuous length of bottom sheets. A rotation mechanism is operative to rotate the receiving roller and pull the continuous web of sheet sets from the delivery guide, across the upper surface of the bed, and onto the receiving roller. A locking mechanism is operative to exert a tension on the continuous web of sheet sets in place on the bed.

This invention is in the field of beds and bedding materials, and more specifically deals with a device to continuously feed clean sheets in order to hygienically and efficiently change sheet sets on a bed.

### BACKGROUND

Bed sheets need to be washed, changed or replaced regularly in order to maintain proper personal hygiene. Changing bed sheets is a very important common practice in the home, as well as in commercial establishments such as hotels and hospitals where there is a high turnover of bed occupants and where sanitation is of utmost importance.

Changing sheets on a bed after each use or after each occupant can be a laborious and costly task. It is time-consuming and inconvenient to have to strip a bed of a used top sheet and a used bottom sheet and to replace the used set of sheets with a clean set of sheets, and subsequently wash the used set of sheets separately and after each use.

Stripping a bed and replacing the used sheets with clean sheets also exposes a person changing the sheets to the risk of back injuries since tightly-fitted sheets can force a person changing traditional sheet sets to have to pull at the sheets in order to get them on or off of the bed. Tightly-fitted sheets are necessary, however, for both comfort and for a clean and neat look. After using the bed once, it is common for the bottom sheet to loosen from the bed and to require additional tucking of the sheets under the mattress to keep the sheets fitted against the bed again.

With traditional sheet sets, there is the additional expense of washing the sheet sets individually and after each use. The increase of cost in water and electricity bills can also be significant where each sheet set is washed and dried after each use in order to replace it on the bed the same day so that the bed can be used immediately for the next occupant or for the next night. The traditional method of changing sheets on a bed can thus be costly in time, health and money. It is therefore desirable to have a device that can hygienically and efficiently change sheet sets on a bed, without exposing the person changing the sheet sets to the health risks associated with manually stripping sheets off of a bed.

Previous attempts to address the problems associated with changing traditional sheet sets have included the use of disposable sheet sets. An example of the use of disposable sheet sets can be found in U.S. Pat. No. 5,718,009 to Lin. However, the use of disposable sheet sets can be expensive and unlike in places like hospitals where disposable sheet sets are required for sanitary purposes, continuous use of disposable sheet sets when not required is detrimental to the environment.

Other attempts to avoid the problems associated with changing traditional sheet sets include devices that use a continuous belt attached to which is a continuous supply of sheets. When the belt is in motion, it causes the used sheets to wind around a roller, while a new portion of the sheet is rolled off of another roller and onto the bed. While these devices provide a convenient way to put clean sheets on a bed, these devices have the problem of allowing the bottom sheet to loosen on the bed, making sleeping on the sheets uncomfortable for the occupant. They furthermore do not provide for a convenient or efficient means for removing the sheets from the bed or off of the rollers for washing or disposal.

Much of the prior art, such as found in U.S. Pat. No. 942,606 to Wilson and U.S. Pat. No. 1,237,170 to Cline, describe only a method or device for changing a single sheet on a bed or table. These types of devices suffer from the problem that for use on a bed, a top sheet must be manually placed over the single bottom sheet since the device does not allow for a way to concurrently change both a bottom and top sheet on a surface.

It is therefore desirable to have a device that can efficiently and hygienically change the sheet sets on a bed while keeping the sheets taut against the bed, is compact, is easy and convenient to use, and that can be used with both disposable and non-disposable sheet sets.

### SUMMARY OF THE INVENTION

It is an object of the present invention to provide a bed-making apparatus that can be used to replace the sheets on a bed, that overcomes problems in the prior art. A method of making a bed using an automated bed-making apparatus to replace and tension the sheet set thereon is also disclosed along with a continuous web of sheet sets for use in an automated bed-making apparatus or method.

One of the key aspects of the present invention is a continuous web of sheet sets which is capable of being used in conjunction with a bed-making apparatus such as that disclosed herein. The continuous web of sheet sets comprises a continuous length of bottom sheets, which are sheets made of bedding material and sized appropriately to cover the sleeping surface of the bed. Each bottom sheet has a head edge and the foot edge for placement when installed on a bed adjacent or in proximity to the head and foot of the bed. The continuous length of bottom sheets is formed by releasably fastening the head edges of the bottom sheets to the foot edges of adjacent bottom sheets. By releasably fastening them, certain bottom sheets can be removed from the continuous web if necessary and it also makes the cleaning possibilities better with respect to the sheet sets.

The continuous web of bedding sheet sets also includes a plurality of top sheets, namely a top sheet corresponding to each bottom sheet which is in the continuous length of bottom sheets. Again each top sheet is sized appropriately to fit the bed and has a head edge, footage and opposing side edges. Each top sheet is attached along its foot edge to a bottom sheet in the continuous length of bottom sheets by attachment parallel to and adjacent to the foot edge of that bottom sheet. The head edge and opposing side edges of each top sheet remain unattached, to maximize freedom of movement for the occupant of the bed when the sheets are in place.

There are many different ways that the bottom sheets which make up the continuous length of bottom sheets within the continuous web can be releasably attached to each other—for example by zippers, Velcro hook and loop fasteners, or other clips and methods of attachment. All such methods of attachment will be understood to be contemplated within the scope of the present invention.

There are two different primary methods of dispensing or releasing the continuous web of sheet sets across the bed surface which are primarily contemplated—the first of which is to roll the continuous web of sheet sets around the delivery roller, as will be outlined further below in respect of the apparatus of the present invention, and the second of which is to fold the continuous web of sheet sets in the dispensable fashion within the container such that they can be pulled out of the container and dispensed across the surface of the bed in that way—in this approach, a different type of the delivery guide would be used then the delivery roller. Both of these methods will be outlined in further detail below but it will also be understood that there may be slight changes which could be made to the continuous web of sheet sets which would optimize their dispensing from either of these methods and all such changes are also contemplated within the scope of the present invention.

One of the key embodiments of the present invention is a bed-making apparatus for changing a sheet set on a bed. Using the bed-making apparatus of the present invention, the user will be able to quickly and cleanly change the bedding on a bed and it is contemplated specifically that the bed-making apparatus of the present invention could have significant utility in commercial, hospitality or healthcare applications. The continuous web of sheet sets of the present invention is used in the continuous bed-making apparatus and method of the present invention.

The bed-making apparatus of the present invention, for use in changing a sheet set on a bed, comprises firstly a delivery guide mountable at an end of the bed. The delivery guide is capable of feeding onto the surface of the bed of continuous web of sheet sets, such as outlined elsewhere herein, which comprises a continuous length of bottom sheet sets which are releasably attached to each other and the plurality of top sheets which are attached along their bottom managed to the corresponding bottom edge of the bottom sheets within the continuous web. The further details of the continuous web of sheet sets are disclosed elsewhere herein.

Depending upon the method of storage of the continuous web of sheet sets, it is primarily contemplated that the continuous web will either be stored for dispensing by rolling around a roller, in which case the delivery guide would comprise the delivery roller rotatably mounted an end of the bed, or alternatively the continuous web could be folded within a boxer receptacle and the delivery guide would potentially be simply a support or delivery member which could guide the continuous web of sheet sets as they were dispensed from the container onto the surface of the bed, and would likely also provide some clamping ability to hold the continuous web of sheet sets in place once they were in the appropriate position [versus a ratcheting lock or the like with respect to a delivery roller]. The delivery guide will in any event deliver the continuous web of sheet sets with their foot edge, or the foot edge of the top sheet in advance of the head edge of the top sheet onto an upper surface of the bed. The reason for this configuration is to avoid problems with the feeding her placement of the sheet sets which could occur by allowing the loose top edge of a top sheet to be dispensed onto the top of the bed rather than an attached footage of the top sheet.

The bed-making apparatus also includes a receiving roller which is rotatably mountable at an end of the bed and which is capable of receiving and rolling there on the continuous web of sheet sets from the delivery guide, so that the continuous web of sheet sets with the foot edge of the top sheet would be received by the receiving roller and by rotation of the receiving roller the continuous web of sheet sets could be actuated across the bed surface and one corresponding pair of top and bottom sheets could be rolled onto the receiving roller for subsequent removal and cleaning while a clean or fresh set of top and bottom sheet were rolled into position across the upper surface of the bed.

A rotation mechanism would also be used to rotate the receiving roller, and hold a continuous web of sheet sets from the delivery guide across the upper surface of the bed onto the receiving roller. The rotation mechanism might either be a manual rotation mechanism such as a crank or the like, or it could also be motorized. Finally there would be a roller locking mechanism which was operative to exert attention in force on the continuous length of sheet sets between the delivery guide and the receiving roller. The roller locking mechanism could take many forms but it is primarily contemplated that would be necessary to be able to lock in position the one end of the continuous web of sheet sets as they were in position on the upper surface of the bed such that they could be pulled or tensioned from the other end. This may consist of either providing a lock or gripping mechanism on the delivery guide and ratcheting locking mechanism on the receiving roller, or vice versa. Any means of tensioning the continuous web of sheet sets in place on the bed is contemplated within the scope hereof.

The delivery guide, as described above, might be a delivery roller which is rotatably mountable at an end of the bed and the continuous web of sheet sets is rolled thereon such that they will be dispensed onto the bed surface by unrolling them from the delivery roller across the bed surface to the receiving roller.

Alternatively, the continuous web of sheet sets might be folded and stored within a container rather than rolled, in which case the delivery guide might be a guide member simply to guide the sheets out of their container onto the surface of the bed, which also included sheet locking means such as a clamp or the like to allow for the clamping and tensioning of the continuous web of sheet sets in position on the bed surface.

The roller locking mechanism would resist rotation of the delivery guide and receiving roller with respect to each other so that the continuous web of sheet sets could be tensioned on the bed surface. In one embodiment the roller locking mechanism could comprise a ratchet wheel fitted onto an end of the receiving roller, a lug pivotally mounted in relation to the ratchet wheel adapted to engage ratchet teeth on the ratchet wheel, and the delivery lock operative to lock the delivery guy, such that the delivery lock could be engaged and then the tensioning applied to the continuous web by ratcheting the receiving roller to tighten the web.

There are multiple configurations to the positioning of the delivery guide and the receiving roller in various embodiments of the present invention. In the first embodiment, the delivery guide in the receiving roller could be positioned at opposing head and foot ends of the bed. In another approach, the delivery guide in the receiving roller could be positioned at the same end of the bed, and the continuous web of sheet sets would pass from the delivery guide under the bed to a distal end of the bed, then up and back over the upper surface of the bed to the receiving roller. Positioning the entirety of the apparatus at one end of the bed, likely the foot end of the bed, would allow for the creation of an integrated device which could be more easily retrofitted to existing bed. Protective housings are patting could be crafted to cover the delivery guide and/or the receiving roller in either the embodiment which has the delivery guide in the receiving roller at opposing ends of the bed, or the single integrated unit.

In the case of the delivery guide in the receiving roller being at the same end of the bed, the bed could comprise a mattress and box spring and the web of sheet sets could pass between the bottom of the mattress on the top of the box spring if the bottom of the mattress and the top of the box spring were provided with a hard surface to allow smooth movement of the continuous web between them. In the case of the mounting of both the delivery guide and the receiving roller at the same end of the bed, there could also be included at least one idler roller for mounting at the distal end of the bed from the apparatus to facilitate movement of the continuous web of sheet sets.

Where the delivery guide is a delivery roller, the delivery roller could have end plates thereon to hold the role of sheet sets in place. The receiving roller in any embodiment of the invention could also have end plates thereon to hold the role of sheet sets in place as the continuous web is received and rolled thereon.

In addition to the bed-making apparatus of the present invention it is also contemplated that the bed-making apparatus of the present invention could be installed in OEM fashion on a bed and it is also contemplated that a bed which included any of the bed making apparatus of the present invention is within the scope hereof.

Beyond the new apparatus of the present invention, being the continuous web of sheet sets, the bed-making apparatus, and a bed incorporating the bed-making apparatus hereof, there is also disclosed herein a novel method of making a bed using a bed-making apparatus. The method would be used with a bed that includes the delivery guide mounted at an end thereof and the receiving roller rotatably mounted at an end thereof, where the delivery guide has sheet locking means thereon and is capable of feeding onto the surface of the bed a continuous web of sheet sets as outlined elsewhere herein. The delivery guide will deliver the continuous web of sheet sets with the foot edge of the top sheet in advance of the head edge of the top sheet onto the upper surface of the bed. The receiving roller would be rotatably mounted that an end of the bed so that it could receive the continuous web of sheet sets as it was extended across the bed from the delivery guide. The method itself would comprise rotating the receiving roller and pulling the continuous web of sheet sets from the delivery guide across the upper surface of the bed and onto the receiving roller such that a new bottom sheet and corresponding top sheet were positioned on the bed between the delivery guide in the receiving roller, and then the top sheet in bottom sheet positioned on top of the surface of the bed could be tensioned in place by locking or tightening the delivery guide and/or the receiving roller.

The method would to a degree depend upon whether the continuous web of sheet sets were rolled on foot delivery roller which was the delivery guide and was rotatably mounted at an end of the bed, or whether the continuous web of sheet sets were folded in the container and the delivery guide in that case would simply be a member of some kind capable of guiding the continuous web onto the bed surface and potentially locking the sheets in place at their exit from the dispenser are container. The method would depend also to degree on whether the delivery guide and the receiving roller were mounted together at the same end of the bed, or whether the delivery guide and the receiving roller remounted at opposing ends of the bed, likely being the delivery guide at the head end of the bed and the receiving roller at the foot end of the bed.

The present invention provides an apparatus wherein separate means are not required for moving both a top sheet and a bottom sheet into place on a bed. The present invention can keep sheets taut against a bed without requiring a user to strain their back, as is required with traditional sheet sets. The present invention is designed to be efficient and hygienic as well as compact and easy to use. Accordingly, the bed-making apparatus can be applied to private and public residences including guest rooms, hotels, lodges, and hospital rooms to conveniently improve the hygiene of bed sheets and to reduce the cost of operations by using continuous sheet sets that guests and occupants of the bed can quickly and easily change themselves.

### DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a top perspective view of one embodiment of the bed-making apparatus of the invention installed on a bed.

FIG. 2 is a side perspective view of the embodiment of FIG. 1.

FIG. 3 is a perspective view of the end of a delivery roller of the embodiment of FIG. 1.

FIG. 4 is a perspective view of the end of a receiving roller and a locking mechanism of the embodiment of FIG. 1.

FIG. 5 is a top view of one embodiment of the continuous web of sheet sets.

FIG. 6 is a top view of top view of one embodiment of the continuous web of sheet sets.

FIG. 7 is a cross-sectional view of the continuous web shown in FIG. 6.

FIG. 8 is a cross-sectional view of the attachment points of the top sheet to the bottom sheet of the continuous web shown in FIG. 7.

FIG. 9 is a side view of an embodiment of the bed-making apparatus of the present invention with housing units.

FIG. 10 is a side cross-sectional view of the bed-making apparatus shown in FIG. 9.

FIG. 11 is a side cross-sectional view of a bed-making apparatus of the present invention wherein the rollers are supported within a box spring.

FIG. 12 is a side cross-sectional view of the bed-making apparatus of FIG. 11 with a pair of idler rollers.

FIG. 13 is a side cross-sectional view of a bed-making apparatus wherein the rollers are supported on the same side of a bed.

FIG. 14 is a side cross-sectional view of the bed-making apparatus of FIG. 13 with a pair of idler rollers.

### DETAILED DESCRIPTION OF THE ILLUSTRATED EMBODIMENTS

As outlined above, the invention is a bed-making apparatus that allows a user to concurrently change a top sheet and a bottom sheet on a bed. A locking mechanism keeps the bottom sheet tightly fitted against the bed, while a continuous web of fresh sheet sets can be stored for later use. This allows a user to quickly and conveniently change the sheets on a bed, while keeping the bed tidy looking and comfortable to sleep in.

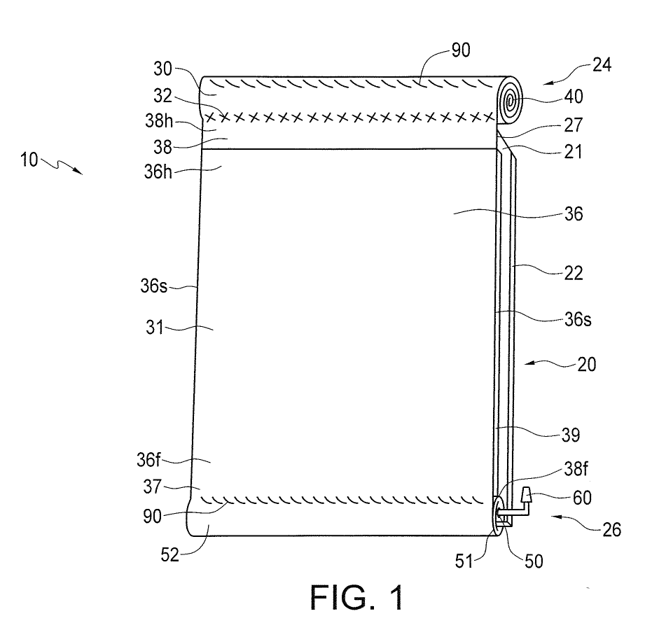

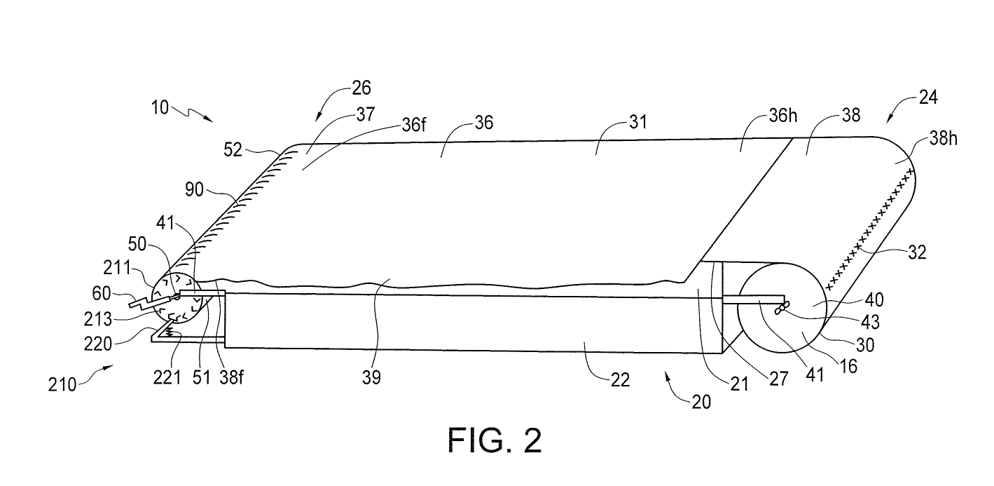

FIG. 1 and FIG. 2 illustrate one embodiment of the bed-making apparatus of the present invention. The bed-making apparatus 10 may be associated with any usual or conventional bed 20, such as one that comprises a mattress 21 and a box spring 22. Typically, the bed 20 comprises a box spring 22 and a mattress 21 on top of the box spring 22, said box spring 22 and mattress 21 positioned horizontally. Both the mattress 21 and the box spring 22 have opposite head 24 and foot ends 26, the mattress having an upper surface 27, with the upper surface 27 of the mattress 21 substantially horizontal.

In the illustrated embodiment, the bed-making apparatus 10 comprises a delivery guide at the head end of the bed, which in this case comprises a rotatably mounted delivery roller 40 at one end 24 of the bed 20. A receiving roller 50 is rotatably mounted at the opposite end 26 of the bed 20. Also provided is a continuous web of sheet sets 31 comprising a continuous length of bottom sheets 38 formed by releasably fastening head edges 38h of the bottom sheets to foot edges 38f of adjacent bottom sheets 38. A plurality of top sheets 36 are also provided wherein each top sheet 36 is attached along a foot edge 36f thereof to the continuous length of bottom sheets 38 adjacent and parallel to a foot edge 38f of a bottom sheet and wherein the head edge 36f and side edges 36s of the top sheet 36 remain unattached such that the head edge 36f and side edges 36s of the top sheet 36 can be raised above the bottom sheet to allow a user to conveniently enter the bed 20 from the side and easily position themselves between the top sheet 36 and the continuous length of bottom sheets 38.

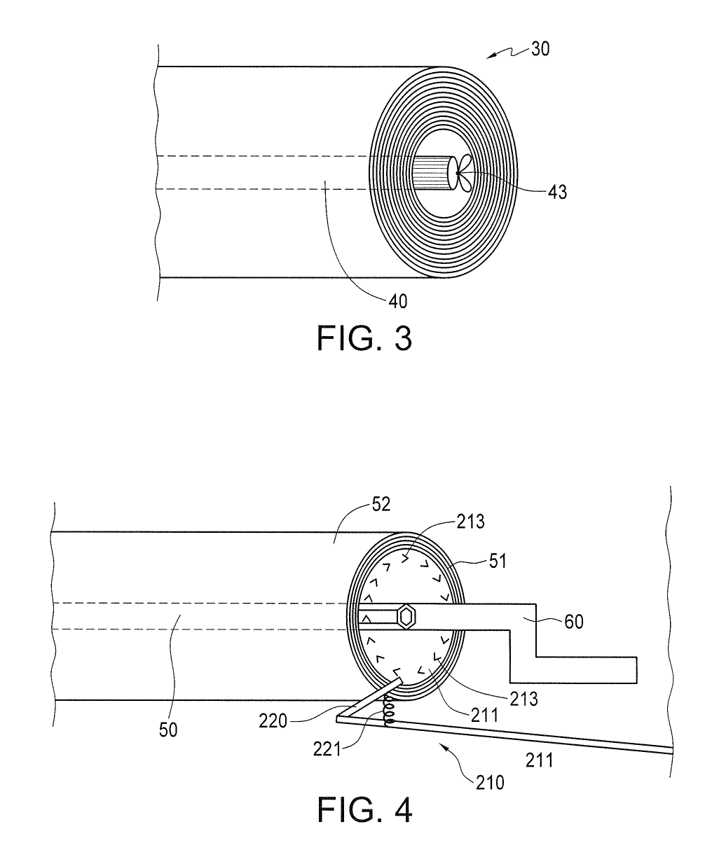

FIG. 3 illustrates the continuous web of sheet sets 31 wound around a delivery roller 40 in an embodiment of the present invention. This continuous web of sheet sets 30 is approximately the same width as the mattress 21, or slightly greater in width and has a width substantially equal to the length of a delivery roller 40, so that the mattress 21 will be covered by the continuous web of sheet sets 31 withdrawn from the continuous web of sheet sets 30. It is understood within the scope of the invention that the continuous web of sheet sets 31 may be adapted in length to be size-for-size the overall length of the bed 20. The continuous web of sheet sets 31 may be of considerable length so that as it is unrolled it will provide a large number of sheet sets that successively cover the mattress 21.

The delivery roller 40 is configured to deliver the continuous web of sheet sets 31 with the foot edge 36f of a top sheet 36 in advance of the head edge 36h of a top sheet 36 onto an upper surface 27 of the bed 20, and the receiving roller 50 is configured to receive the continuous web of sheet sets 31 with the foot edge 36f of a top sheet 36 in advance of the head edge 36h of a top sheet 36 from the upper surface 27 of the bed 20. In this way, the foot edge 36f of the top sheet 36 is both delivered and received first from both the delivery roller 40 and the receiving roller 50, respectively, with the head edge 36h of the top sheet 36 trailing behind to allow for easy delivery and receiving of each sheet set onto the respective rollers 40 and 50. It is anticipated that the foot end 36f of the top sheet 36, when placed on the bed 20, will be positioned at a foot end 26 of the bed 20 so that the head end 36h of the top sheet is at the head end 24 of the bed 20. The first end of the continuous web of sheet sets 31 is attached to the delivery roller 40 and the continuous web of sheet sets 31 are wound around the delivery roller 40 to create the continuous web of sheet sets 30. The second end of the continuous web of sheet sets 31 is attached to the receiving roller 50. Each of the ends of the continuous web of sheet sets 31 are removable whereby the sheet sets at the ends of the continuous web of sheet sets 31 may be removed from the delivery roller 40 or the receiving roller 50 and laundered for replacement in the bed-making apparatus 10.

Referring again to FIG. 1 and FIG. 2, the continuous web of sheet sets 30 may be supported in any suitable way, and in the embodiment shown in the figures, it is supported on brackets 41 which receive the shaft of the delivery roller 40 on which the continuous web of sheet sets 31 are wound. It is understood that any supporting axles affixed to two opposite sides so as to support the delivery roller 40 in a rotatable manner can be used. The brackets 41 are spaced laterally of the bed 20 and exterior thereto and are so positioned vertically of the bed 20 that the continuous web sheet sets 31 from the continuous web of sheet sets 30 will pass, with a foot edge 36f of a top sheet 36 first, easily onto the upper surface 27 of the mattress 21. The brackets 41 are so constructed that the continuous web of sheet sets 30 may be easily put into and taken out of the supporting relation with the brackets 41.

FIG. 4 illustrates the receiving roller 50 in an embodiment of the present invention. At the foot end 26 of the bed 20 is a second pair of brackets 41 which are spaced laterally of the bed 20 to support a shaft of the receiving roller 50 around which used sheet sets 51 may be wound to create a roll of used sheet sets 52.

Referring again to FIG. 1 and FIG. 2, the continuous web of sheet sets 30 is placed within the brackets 41 at the head end 24 of the bed 20 and a forward end 37 of the continuous web of sheet sets 31 is pulled from the continuous web of sheet sets 30 over the upper surface 27 of the mattress 21 and is attached to the shaft of the receiving roller 50 at the foot end 26 of the bed 20, although it will be apparent to those skilled in the art that the described positions of the rollers 40 and 50 may be reversed so that the delivery roller 40 holding the continuous web of sheet sets 30 will be at the foot end 26 of the bed 20 and the used roll 52 at the head end 24. Rollers 40 and 50 could optionally be equipped with end plates 16 on either ends of the shafts in order to hold the rolls of sheets in place on the shafts 30 and 52, as shown on the delivery roller 40 in FIG. 2.

A rotation mechanism 60 is provided and is operative to rotate the receiving roller 50 and pull the continuous web of sheet sets 31 from the delivery roller 40, across the upper surface 27 of the bed 20, and onto the receiving roller 50. In an embodiment of the present invention the rotation mechanism 60 comprises a crank coupled to the receiving roller 50. A locking mechanism 210 is operative to exert a tension on the continuous web of sheet sets 31 between the delivery roller 40 and the receiving roller 50. The locking mechanism 210 comprises a ratchet wheel 211 fitted on an end of the receiving roller 50 and a lug 220 pivotally mounted in relation to the ratchet wheel 211 and adapted to engage ratchet teeth 213 on the ratchet wheel 211. The lug 220 could be pivotally mounted by any suitable means such as via a spring 221 or the like. A delivery lock 43 is operative on the delivery roller 40 to prevent the delivery roller 40 from rotating. The delivery lock 43 could be a pin through the shaft of the delivery roller 40 or other like means which would prevent the delivery roller from rotating. In this way, the locking mechanism 210 resists rotation of the delivery and receiving rollers 40 and 50 with respect to each other.

In operation, a user engages the rotation mechanism 60, or crank attached to the receiving roller 50, to cause the continuous web of sheet sets 31 on the upper surface 27 of the mattress 21 to move toward the receiving roller 50. This causes the ratchet teeth 213 of the ratchet wheel 211 to disengage the lug 220 and allows the receiving roller 50 to rotate. As the receiving roller 50 rotates, it pulls the continuous web of sheet sets 31 on the upper surface 27 of the mattress 21, causing it to wind around the receiving roller 50. As the continuous web of sheet sets on the upper surface 27 of the mattress 21 is wound around the receiving roller 50, the continuous web of sheet sets 31 pulls on the delivery roller 40 causing the delivery roller 40 to rotate. The delivery roller 50 concurrently releases a freshly laundered sheet set which slides into place on the upper surface 27 of the mattress 21 in place of the previous sheet set. When the freshly laundered sheet set is in place on the upper surface 27 of the mattress 21, the user ceases to turn the crank 60, which stops the rollers 40 and 50 from rotating, and consequently stops the continuous web of sheet sets 31 from moving. At this point, the lug 220 engages the ratchet teeth 213 on the ratchet wheel 211, preventing the receiving roller 50 from rotating backward. The delivery lock 43 on the delivery roller 40 is engaged which also prevents the delivery roller 40 from rotating backward. When the crank 60 is further turned in a forward direction, tension is created in the sheet set between the delivery roller 40 and the receiving roller 50. As the lug 220 engages successive ratchet teeth 213, again locking the receiving roller 50 from rotating backward, the tension created on the sheet set between the delivery roller 40 and the receiving roller 50 is maintained. This ratchet effect in combination with the locking mechanism 210 will result in tension on the sheets between the delivery roller 40 and the receiving roller 50 and prevents backward rotation of the delivery roller 40 and receiving roller 50 and the consequent loosening of the continuous web of sheet sets 31 on the mattress 21. Additionally, the delivery roller 40 could be fitted with a clutch system that, when engaged, prevents the delivery roller 40 from rotating and that disengages only when a sufficient amount of force is applied to the continuous web of sheet sets 31 on the upper surface 27 of the mattress 21 by engaging the rotation mechanism 60, which would then allow the delivery roller 40 to rotate. After the continuous web of sheet sets 31 on the upper surface 27 of the mattress 21 has been used and when it is desired to replace it, the rotation mechanism 60 is engaged to rotate the receiving roller 50 and the used roll of sheet sets 52, which causes the continuous web of sheet sets 31 to be moved from the upper surface 27 of the mattress 21 onto the roll of used sheet sets 52 and a new length of the continuous web of sheet sets 31 to be drawn from the continuous web of sheet sets 30 onto the upper surface 27 of the mattress 21. It is anticipated that the rotation mechanism 60 could be manually operated, or alternatively, could be coupled to a motor for automatic bed-making. The sheet sets 31 act as a coupling device to the rollers 40 and 50 to allow for conjoint rotation about their axes.

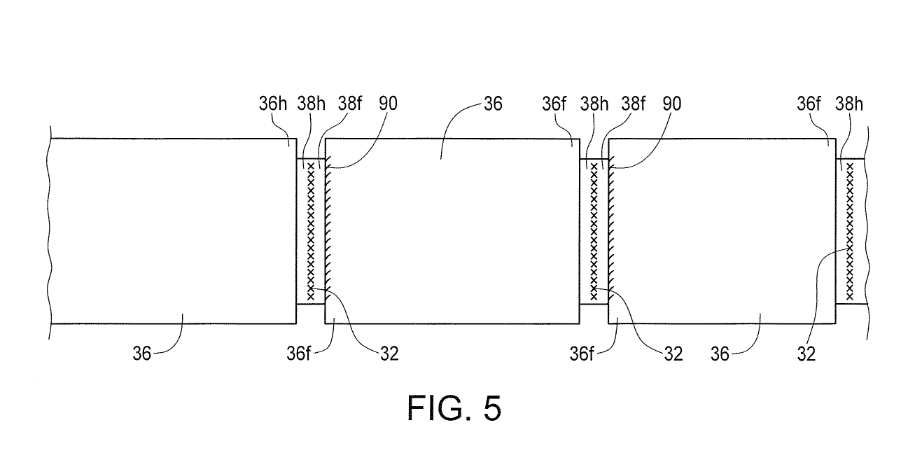

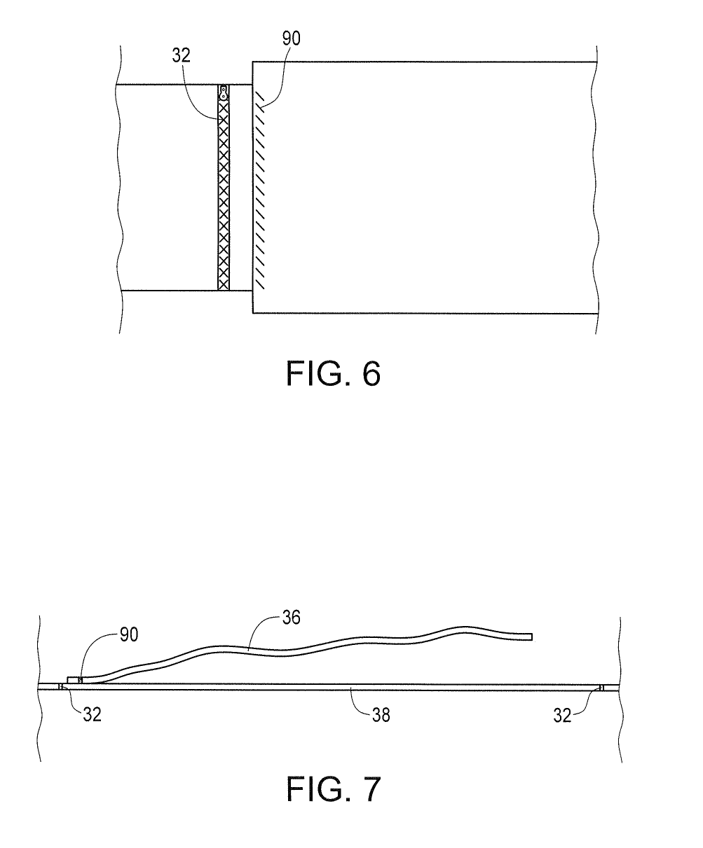

It will be seen from the foregoing description that the continuous web of sheet sets 31 drawn off of the delivery roller 40 onto the receiving roller 50 will provide only one sheet set on the upper surface 27 of the mattress 21 with the head edge 36h of the top sheet 36 substantially in place at the head end 24 of the bed 20, and the foot edge 36f of the top sheet 36 substantially in place at the foot end 26 of the bed 20. FIG. 5 and FIG. 6 illustrate the continuous web of sheet sets 31 in an embodiment of the invention. Each top sheet 36 is attached to the continuous length of bottom sheets 38 by lines of stitching 90 or the like, as shown in FIG. 7, such that the side edges 36s of the top sheet 36 remain unattached from the continuous length of bottom sheets 38 and a person may raise either side edge 36s of the top sheet 36 and the head edge 36h of the top sheet 36 above the continuous length of bottom sheets 38 to enter the bed 20 and position themselves between the top sheet 36 and the continuous length of bottom sheets 38 in the normal and usual way. The continuous length of bottom sheets is 38 formed by releasably fastening head edges of the bottom sheets to foot edges of adjacent bottom sheets 38 at attachment points 32 to allow for easy removal and convenient washing. A variety of releasable fasteners are available for this purpose including zippers, hook and loop fasteners, buttons, and snap fasteners. In the embodiment shown in FIG. 6, a zipper is used for this purpose. FIG. 8 shows an alternate embodiment wherein hook and loop fasteners are used to releasably fasten a top sheet 36 to the continuous length of bottom sheets 38. In that embodiment, the top sheet 36 is fitted with a first mating member 44 and the bottom sheet 38 is fitted with a second mating member 45, such that when the first and second mating members 44 and 45 are pressed together, the mating members 44 and 45 releasably fasten the top sheet 36 and the bottom sheet 38 together. It is understood by those skilled in the art that the bottom sheet 38 can be fitted with the first mating member 44 and the top sheet 36 can be fitted with the second mating member 45, and the invention would work in the same manner. The material of the continuous web of sheet sets 31 could be washable or alternatively, could be made of a disposable material such as durable elastic paper, knitting tissue, compressed tissue, or paper cloth. The top sheet 36 may be the same width as the continuous length of bottom sheets 38, or more conveniently, the top sheet 36 may be greater in width than the continuous length of bottom sheets 38 and the width of the bed 20 to allow the top sheet 36 to drape over the side edges of the mattress 21 in the normal and usual fashion. In this way, the top sheet 38 provides for overhanging edges 39 of the top sheet 36 to allow for complete coverage when a person is positioned between the top sheet 36 and the continuous length of bottom sheets 38 and to more fully cover the sides of the mattress 21. It will be apparent that after the continuous web of sheet sets 31 on top of the mattress 21 has been used and it is desired to change the continuous web of sheet sets 31, the crank 60 may be operated to draw the continuous web of sheet sets 31 off of the delivery roller 40 and onto the receiving roller 50 until the used sheet set has been drawn off the mattress 21 and a new sheet set has been drawn into sleeping positions on the mattress 21.

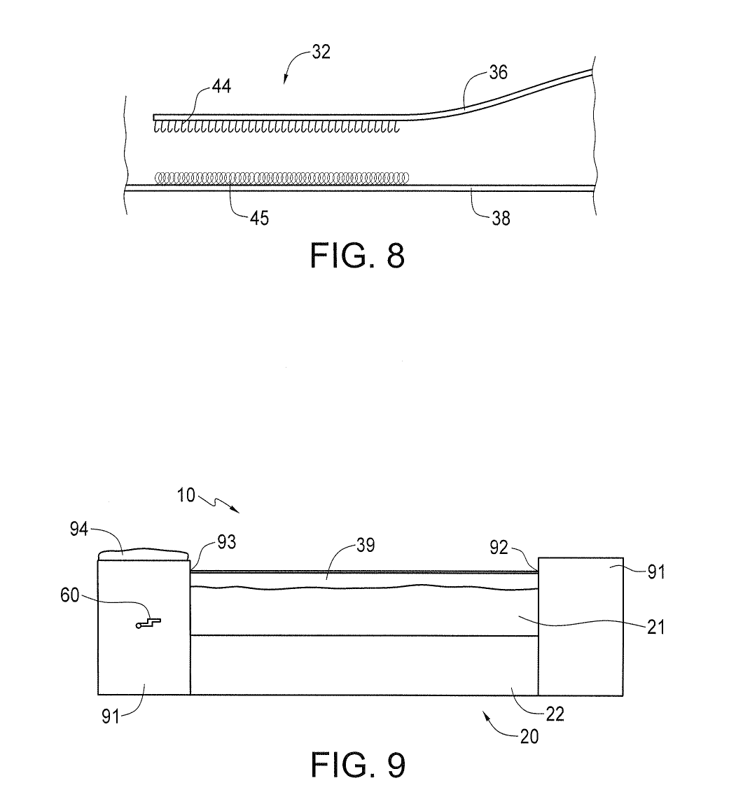

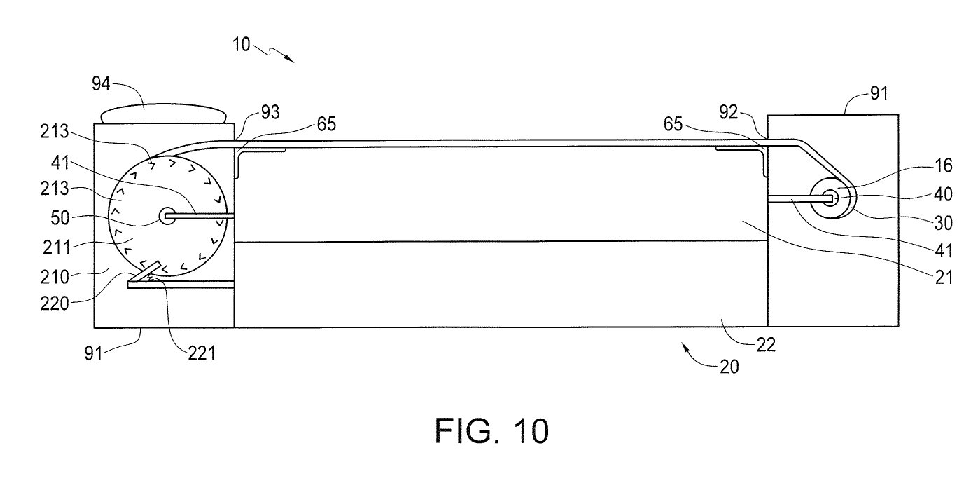

The bed-making apparatus 10 could further include housings 91 as shown in FIG. 9 and FIG. 10, within which the rollers 40 and 50 supporting the rolls of sheets 30 and 52, respectively, are mounted. A housing 91 supporting the continuous web of sheet sets 30 has a delivery slit 92 adapted for delivering the continuous web of sheet sets 31 via the delivery slit 92 to the upper surface 27 of the bed 20. At the other end, the housing 91 supporting the used roll of sheet sets 52 has a receiving slit 93 for the incoming of the used sheet set 31 to roll onto the receiving roller 50. The top or the side of the housings 91 would be adapted to be easily opened to replace the continuous web of sheet sets 31 when required. The top of the housing 91 could also accommodate a cushion 94 for practical purposes as a bedside bench.

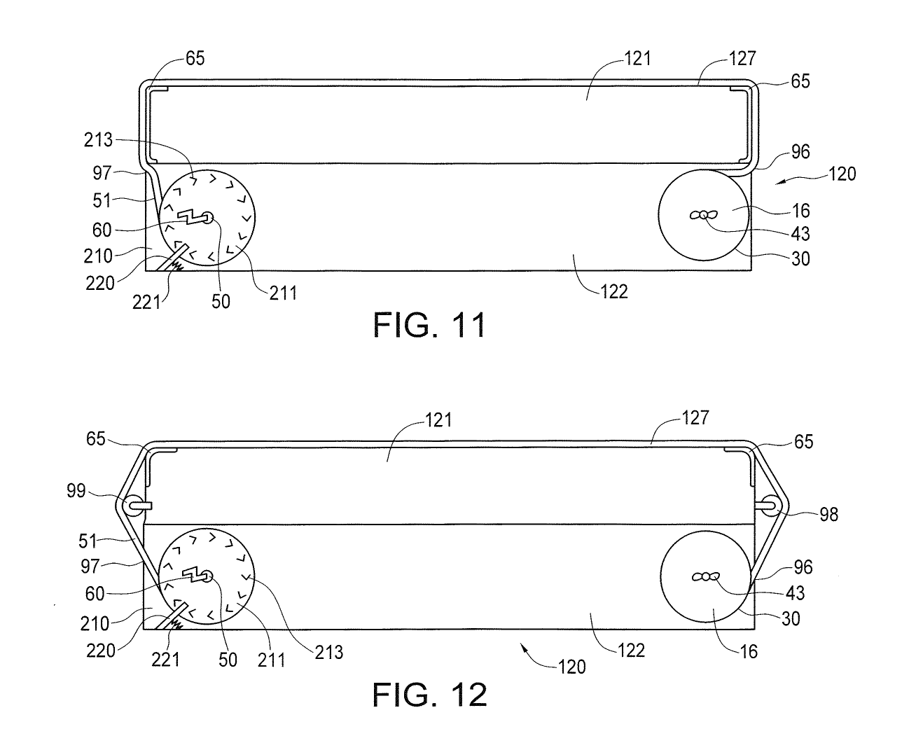

FIG. 11 illustrates an alternative embodiment of the present invention wherein the sets of rollers 40 and 50 could be mounted within a box spring 122 of a bed 120, also with a delivery slit 96 in the box spring 122 adapted for delivering the continuous sheet sets 31 to a receiving slit 97 in the other side of the box spring 122. A set of idler rollers could optionally be provided, as shown in FIG. 12, comprising a first idler roller 98 and a second idler roller 99 for easy delivery of the sheet sets 31 across an upper surface 127 of a mattress 121.

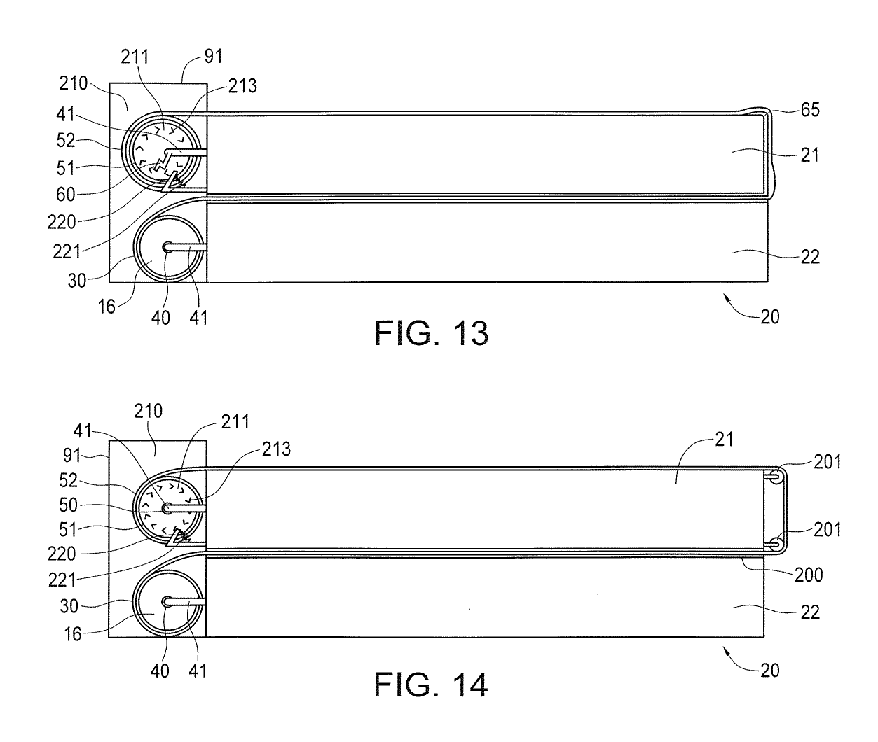

In a further embodiment shown in FIG. 13, the delivery roller 40 and the receiving roller 50 are rotatably positioned at the same end 24 or 26 of the bed 20 with the continuous web of sheet sets 31 passing from the delivery roller 40 under the bed 20 to a distal end of the bed 20, then up and back over the upper surface 27 of the bed 20 to the receiving roller 50. Optionally, the continuous web of sheet sets 31 passes between a bottom surface of the mattress 21 and a top surface of the box spring 22 and the bottom surface of the mattress 21 and the top surface of the box spring 22 are provided with a hard surface 200 to allow smooth movement of the continuous web of sheet sets 31 therebetween. The hard surface 200 provided between the mattress 21 and the box spring 22 provides a smooth surface for the continuous web of sheet sets 31 to slide on for delivery to the receiving roller 50. As the delivery roller 40 rolls out fresh sheet sets onto the upper surface 27 of the mattress 21, the used sheets are moved along the hard surface 200 between the mattress 21 and the box spring 22. The hard surface 200 could be made Of any material that provides a smooth surface including metal or a hard plastic. The bed-making apparatus 10 could also be provided with at least one idler roller 201 mounted on the distal end of the bed 20 to facilitate movement of the continuous web of sheet sets 31 set around the end of the bed 20 and into the hard surface 200.

Referring to FIGS. 10, 11, 12, and 13, smooth protective covers 65 may optionally be provided on the upper surface 27 of the bed 20 to provide protection against wearing of the mattress 21 from the continuous web of sheet sets 31 being rolled over the upper surface 27, and also to provide a smooth surface to facilitate the continuous web of sheet sets 31 easily sliding over the top surface 27 of the mattress 21.

While it is primarily contemplated that the continuous web of sheet sets would be wrapped around the delivery roller being the delivery guide for use in association with many embodiments of the present invention, and a new continuous web of sheet sets could either be put onto the bed by winding a new web onto the existing delivery roller, or alternatively by simply clipping often replacing the delivery roller which was empty with the new one which contained the new continuous web of sheet sets, there is also contemplated an alternate approach in which rather than being rolled around a delivery roller, the clean continuous web of sheet sets would be stored in a folded fashion in the container. If the continuous web of sheet sets was folded, the delivery guide of the present invention might comprise some kind of a cross member which was simply able to support the continuous web as it was the stance across the upper surface of the bed, which would also include some kind of gripping or clamping means to allow for the holding in place of the continuous web when the sheet set was in place on the upper surface of the bed. Provided there was some ability to clamp the continuous web of sheets in place when the appropriate sheet set was dispensed onto the bed surface, the delivery guide in this type of an embodiment might simply be a member across the top of which the continuous web could be slid or fed and would not necessarily be required to roll or need to provide other mechanical movement. The delivery guide in this context might also be a cross member across the top of which the delivery lock was a second member with teeth or other gripping means on it which could when clamped down and position against the delivery guide lock the continuous web in place. Many different types of delivery locks in this type of an approach are contemplated and all will be understood to be within the scope of the present invention.

It will also be understood by those skilled in the art that in addition to the bed-making apparatus of the present invention and the continuous web of sheet sets used there with, the integration of the bed-making apparatus of the present invention directly into a bed such that an OEM product which included the bed-making apparatus of the present invention would also be contemplated herein.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

What is claimed is:

1. A bed-making apparatus for changing a sheet set on a bed, comprising:
a. a delivery guide mountable at an end of the bed, the delivery guide capable of feeding onto the surface of the bed a continuous web of sheet sets comprising:
i. a continuous length of bottom sheets, each bottom sheet having a head edge and a foot edge, said continuous length being formed by releasably fastening the head edges of the bottom sheets to foot edges of adjacent bottom sheets;
ii. a plurality of top sheets corresponding to the number of bottom sheets in the continuous length, each top sheet having a head edge, a foot edge, and opposite side edges, wherein each top sheet is attached along its foot edge to a bottom sheet in the continuous length parallel and adjacent to the foot edge thereof; and wherein the head edge and opposite side edges of each top sheet remain unattached;
whereby the delivery guide will deliver the continuous web of sheet sets with the foot edge of a top sheet in advance of the head edge of a top sheet onto an upper surface of the bed;
b. a receiving roller rotatably mountable at an end of the bed and capable of receiving and rolling thereon the continuous web of sheet sets from the delivery guide, configured to receive the continuous web of sheet sets with the foot edge of a top sheet in advance of the head edge of a top sheet from the upper surface of the bed;
c. a rotation mechanism operative to rotate the receiving roller and pull the continuous web of sheet sets from the delivery guide across the upper surface of the bed onto the receiving roller; and
d. a roller locking mechanism operative to exert a tension on the continuous web of sheet sets between the delivery guide and the receiving roller.

2. The bed-making apparatus of claim 1 wherein the delivery guide is a delivery roller which is rotatably mountable at an end of the bed and the continuous web of sheet sets is rolled thereon, wherein the continuous web of sheet sets can be moved onto the bed surface by unrolling them from the delivery roller.

3. The bed-making apparatus of claim 1 wherein the delivery guide is a guide member with sheet locking means to lock the continuous web of sheet sets as it passes thereover, such that the continuous web can be fed from a folded source of continuous sheet sets and locked in position relative to the delivery guide using the sheet locking means.

4. The bed-making apparatus of claim 1, wherein the rotation mechanism comprises a crank coupled to the receiving roller.

5. The bed-making apparatus of claim 1, wherein the rotation mechanism comprises a motor attached to the receiving roller.

6. The bed-making apparatus of claim 1, wherein the roller locking mechanism resists rotation of the delivery guide and receiving roller with respect to each other.

7. The bed-making apparatus of claim 1, wherein the roller locking mechanism comprises:
a. a ratchet wheel fitted on an end of the receiving roller;
b. a lug pivotally mounted in relation to the ratchet wheel and adapted to engage ratchet teeth on the ratchet wheel; and
c. a delivery lock operative to lock the delivery guide.

8. The bed-making apparatus of claim 1, wherein the delivery guide and the receiving roller are to be positioned at opposing head and foot ends of the bed.

9. The bed-making apparatus of claim 8, further comprising a housing to protect the delivery guide and the unused continuous web of sheet sets.

10. The bed-making apparatus of claim 8, further comprising a housing to protect the contents of the receiving roller.

11. The bed-making apparatus of claim 1, wherein the delivery guide and the receiving roller are to be positioned at the same end of the bed.

12. The bed-making apparatus of claim 11, wherein the continuous web of sheet sets passes from the delivery guide under the bed to a distal end of the bed, then up and back over the upper surface of the bed to the receiving roller.

13. The bed-making apparatus of claim 11, wherein the bed comprises a mattress and a box spring and the continuous web of sheet sets passes between a bottom surface of the mattress and a top surface of the box spring and the bottom surface of the mattress and the top surface of the box spring are provided with a hard surface to allow smooth movement of the continuous web of sheet sets therebetween.

14. The bed-making apparatus of claim 11, further comprising at least one idler roller for mounting on the distal end of the bed from the apparatus to facilitate movement of the continuous web of sheet sets.

15. The bed-making apparatus of claim 11 further comprising a housing to cover the apparatus and protect the unused sheet sets and contents of the receiving roller.

16. The bed-making apparatus of claim 2 further comprising end plates on the delivery roller to hold the roll of sheet sets in place on the delivery roller.

17. The bed-making apparatus of claim 1 further comprising end plates on the receiving roller to hold the roll of sheet sets in place on the receiving roller.

18. The bed making apparatus of claim 1 wherein a width of the top sheet is greater than a width of the bed.

19. A continuous web of sheet sets, comprising:
a. a continuous length of bottom sheets, each bottom sheet having a head edge and a foot edge, said continuous web being formed by releasably fastening the head edges of the bottom sheets to foot edges of adjacent bottom sheets;
b. a plurality of top sheets corresponding to the bottom sheets in the continuous web, each top sheet having a head edge, a foot edge, and opposite side edges;
c. wherein each top sheet is attached along its foot edge to a bottom sheet in the continuous length of bottom sheets parallel and adjacent to its foot edge; and
d. wherein the head edge and opposite side edges of each top sheet remain unattached.

20. The continuous web of sheet sets of claim 19 wherein the bottom sheets are releasably fastened together by one of zippers and mated hook and loop fasteners.

21. The continuous web of sheet sets of claim 19 wherein the continuous web is folded for storage in a dispenser such that the foot edge of the first bottom sheet of the continuous length the bottom sheets would be first dispensed from the continuous web in a way that would result in the continuous web being drawn across the surface of a bed such that the foot end of the top sheet attached adjacent and parallel thereto would travel across the upper surface of the bed before the free head and opposing side edges of the top sheet.

22. A bed including the bed-making apparatus of claim 1.
